(19) United States
(12) Patent Application Publication
(10) Pub. No.: US 2015/0213320 A1
(43) Pub. Date: Jul. 30, 2015

(54) ELECTRONIC DEVICE AND METHOD FOR PROCESSING HANDWRITTEN DOCUMENT

(71) Applicant: Kabushiki Kaisha Toshiba, Tokyo (JP)

(72) Inventors: Yasuhiro Ookawara, Kunitachi-shi (JP); Yukihiro Kurita, Kokubunji-shi (JP); Takehiro Ogawa, Hamura-shi (JP); Atsushi Kakemura, Kokubunji-shi (JP)

(21) Appl. No.: 14/327,426

(22) Filed: Jul. 9, 2014

(30) Foreign Application Priority Data
Jan. 24, 2014 (JP) 2014-011212

(51) Int. Cl. G06K 9/00; G06F 17/27

(52) U.S. Cl. CPC G06K 9/00865; G06F 17/2765

(57) ABSTRACT

According to one embodiment, an electronic device includes a display processor and a processor. The display processor displays on a screen a handwritten document includes a plurality of handwritten strokes. If copy of the handwritten document is requested, the processor executes a process for reshaping the handwritten document to convert the handwritten document to first data of a first data format viewable by a plurality of kinds of application programs, and stores the first data in a clipboard for exchanging data between application programs.

### CROSS-REFERENCE TO RELATED APPLICATIONS

This application is based upon and claims the benefit of priority from Japanese Patent Application No. 2014-011212, filed Jan. 24, 2014, the entire contents of which are incorporated herein by reference.

### FIELD

Embodiments described herein relate generally to a technique of processing a handwritten document.

### BACKGROUND

In recent years, various kinds of electronic devices, such as a tablet, a PDA and a smartphone, have been developed. These kinds of electronic devices are widely gaining in popularity as tools for creating or viewing various digital contents, such as presentation data, document data, spread sheet data, and image data.

In addition, recently, an electronic device, which can handle a handwritten document, has begun to be developed.

However, conventionally, no consideration has been given to a technique for making it easier to make use of a handwritten document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary view illustrating a cooperative operation between the electronic device of the embodiment and an external apparatus.

FIG. 3 is a view illustrating an example of a handwritten document which is handwritten on a touch-screen display of the electronic device of the embodiment.

FIG. 4 is an exemplary view for explaining time-series information corresponding to the handwritten document of FIG. 3, the time-series information being stored in a storage medium by the electronic device of the embodiment.

FIG. 5 is an exemplary block diagram illustrating a system configuration of the electronic device of the embodiment.

FIG. 6 is an exemplary block diagram illustrating a functional configuration of a handwriting note application program which is executed by the electronic device of the embodiment.

FIG. 7 is a view illustrating an example of an edit screen which is displayed by the electronic device of the embodiment.

FIG. 8 illustrates an example of some buttons displayed on the edit screen of FIG. 7.

FIG. 9 is an exemplary view for explaining a copy process which is executed by the electronic device of the embodiment.

FIG. 10 is an exemplary view illustrating a process of pasting data from an internal buffer, the process being executed by the electronic device of the embodiment.

FIG. 11 is an exemplary view illustrating a process of pasting data from a clipboard, the process being executed by the electronic device of the embodiment.

FIG. 12 illustrates an example of some application select buttons displayed on the edit screen of FIG. 7.

FIG. 13 is an exemplary view for explaining two kinds of reshaping methods which are selectively used by the electronic device of the embodiment.

FIG. 14 is an exemplary view for explaining another reshaping method which is used by the electronic device of the embodiment.

FIG. 15 is an exemplary flowchart illustrating a procedure of a copy process which is executed by the electronic device of the embodiment.

FIG. 16 is an exemplary flowchart illustrating a procedure of a paste process which is executed by the electronic device of the embodiment.

FIG. 17 is an exemplary flowchart illustrating another procedure of the copy process which is executed by the electronic device of the embodiment.

### DETAILED DESCRIPTION

Various embodiments will be described hereinafter with reference to the accompanying drawings.

In general, according to one embodiment, an electronic device includes a display processor and a processor. The display processor displays on a screen a handwritten document comprising a plurality of handwritten strokes. If copy of the handwritten document is requested, the processor executes a process for reshaping the handwritten document to convert the handwritten document to first data of a first data format viewable by a plurality of kinds of application programs, and stores the first data in a clipboard for exchanging data between application programs.

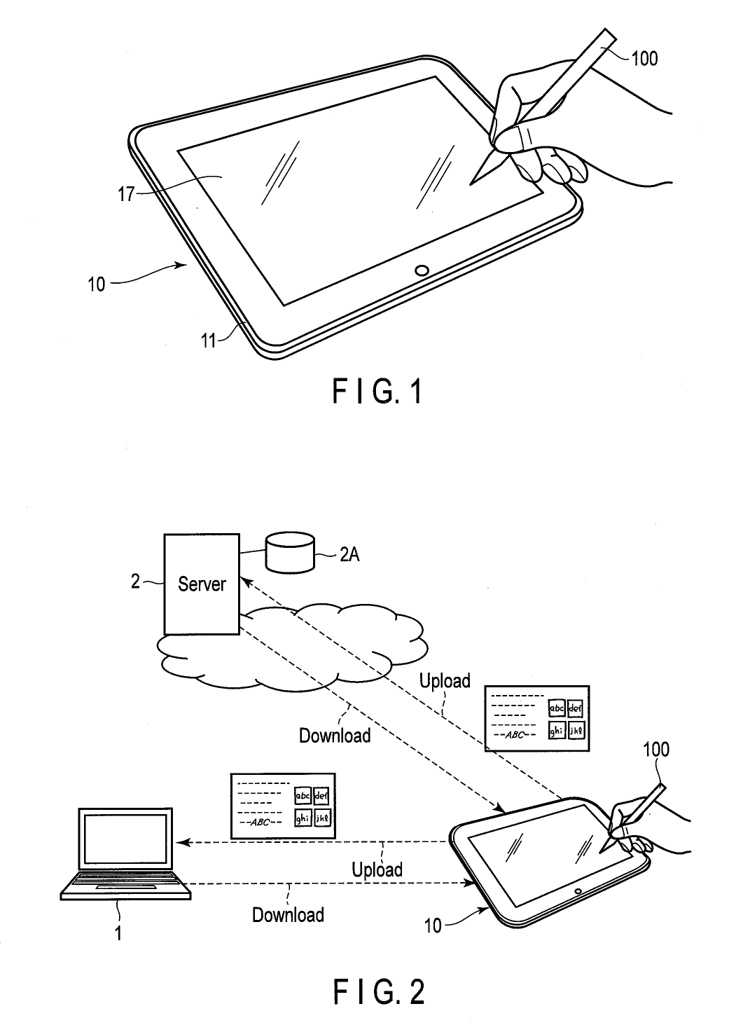

FIG. 1 is a perspective view illustrating an external appearance of an electronic device according to an embodiment. The electronic device is, for instance, a pen-based portable electronic device which can execute a handwriting input by a pen (stylus) or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor are assembled. This sensor is configured to detect a touch position of a pen or a finger on the screen of the flat-panel display. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

The touch-screen display 17 can detect not only a touch operation on the screen with use of a finger, but also a touch operation on the screen with use of a pen 100. The pen 100 may be, for instance, a digitizer pen (electromagnetic-induction pen).

The user can execute a handwriting input operation on the touch-screen display 17 by using the pen 100. During the handwriting input operation, a locus of movement of the pen 100 on the screen, that is, a stroke which has been handwritten by the handwriting input operation (a locus of a handwritten stroke), is drawn in real time, and thereby a plurality of handwritten strokes which have been input by handwriting are displayed on the screen. A locus of movement of the pen 100 during a time in which the pen 100 is in contact with the screen corresponds to one stroke. A set of many strokes corresponding to handwritten characters, handwritten figures (handwritten shapes), handwritten tables, etc. constitutes a handwritten document.

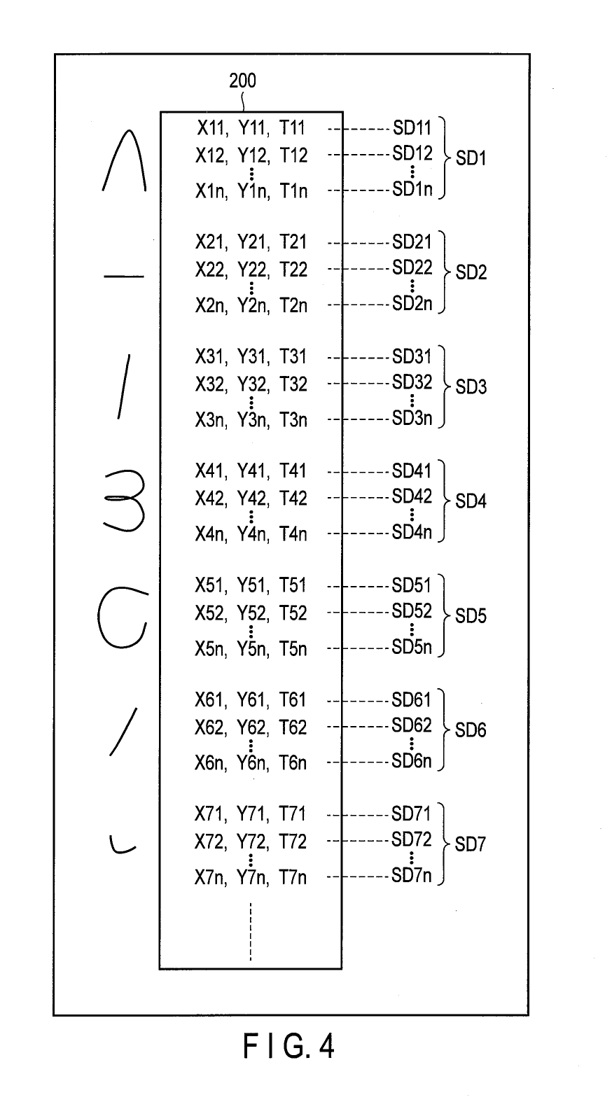

In the present embodiment, this handwritten document is stored in a storage medium not as image data but as time-series information (handwritten data) indicative of coordinate series of the loci of strokes and the order relation between the strokes. The details of this time-series information will be described later with reference to FIG. 4. This time-series information indicates an order in which a plurality of strokes are handwritten, and includes a plurality of stroke data corresponding to a plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes are handwritten.

The tablet computer 10 can read out arbitrary existing time-series information from the storage medium, and can display on the screen a handwritten document corresponding to this time-series information, that is, a plurality of strokes indicated by this time-series information. Strokes indicated by the time-series information are also strokes input by handwriting.

Furthermore, the tablet computer 10 has an edit function. The edit function can delete or move an arbitrary handwritten part (a handwritten character, a handwritten mark, a handwritten figure, a handwritten table, etc.) in a displayed handwritten document which is selected by a range select tool, in accordance with an edit operation by the user with use of an “eraser” tool, the range select tool, and other various tools.

In this embodiment, the handwritten document may be managed as one page or plural pages. In this case, the time-series information (handwritten data) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can wirelessly communicate with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit time-series information (handwritten data) to the personal computer 1 over a network, and can store the time-series information (handwritten data) in the HDD of the personal computer 1 (“upload”).

In addition, the tablet computer 10 can read out (“download”) one or more arbitrary time-series information pieces stored in the HDD of the personal computer 1, and can display strokes indicated by the read-out time-series information on the screen of the display 17 of the tablet computer 10. In this case, the tablet computer 10 may display on the screen of the display 17 a list of thumbnails which are obtained by reducing in size pages of plural time-series information pieces, or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit time-series information (handwritten data) to the server 2 over the network, and can store the time-series information (handwritten data) in a storage device 2A of the server 2 (“upload”). Besides, the tablet computer 10 can read out arbitrary time-series information which is stored in the storage device 2A of the server 2 (“download”) and can display the loci of strokes indicated by the time-series information on the screen of the display 17 of the tablet computer 10.

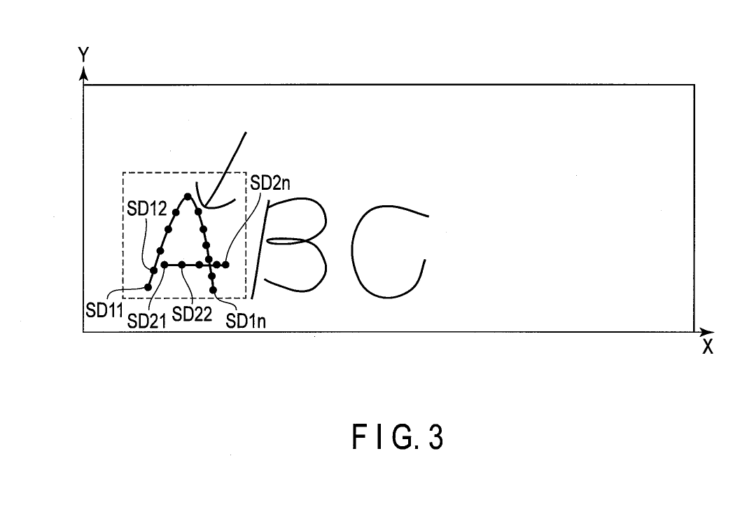

Next, referring to FIG. 3 and FIG. 4, a description is given of a relationship between strokes (characters, figures, tables, etc.), which are handwritten by the user, and time-series information. FIG. 3 shows an example of a handwritten document which is handwritten on the touch-screen display 17 by using the pen 100 or the like.

In many cases, on a handwritten document, other characters or figures are handwritten over already handwritten characters or figures. In FIG. 3, the case is assumed that a handwritten character string “ABC” was handwritten in the order of “A”, “B” and “C”, and thereafter a handwritten arrow was input by handwriting near the handwritten character “A”.

The handwritten character “A” is expressed by two strokes (a locus of “̂” shape, a locus of “-” shape) which are handwritten by using the pen 100 or the like, that is, by two loci. The locus of the pen 100 of the first handwritten “̂” shape is sampled in real time, for example, at regular time intervals, and thereby time-series coordinates SD11, SD12, . . . , SD1n of the stroke of the “̂” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order in which the strokes are handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the “A” shape of the handwritten character “A”, that is, an n-number of coordinate data SD11, SD12, . . . , SD1n. The stroke data SD2 includes coordinate data series corresponding to the points on the locus of the stroke of the “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “̂” shape. The coordinate data SD1n is indicative of an X coordinate (X1n) and a Y coordinate (Y1n) of the end point of the stroke of the “̂” shape.

Further, each coordinate data may include time stamp information T corresponding to a time point at which a point corresponding to this coordinate data was handwritten. Moreover, information (Z) indicative of a pen stroke pressure may be added to each coordinate data.

In the present embodiment, as described above, the handwritten document is stored as the time-series information 200 which is composed of a set of time-series stroke data. Thus, handwritten characters can be handled, without depending on languages of the handwritten characters. Therefore, the structure of the time-series information 200 of the present embodiment can be commonly used in various countries of the world where different languages are used.

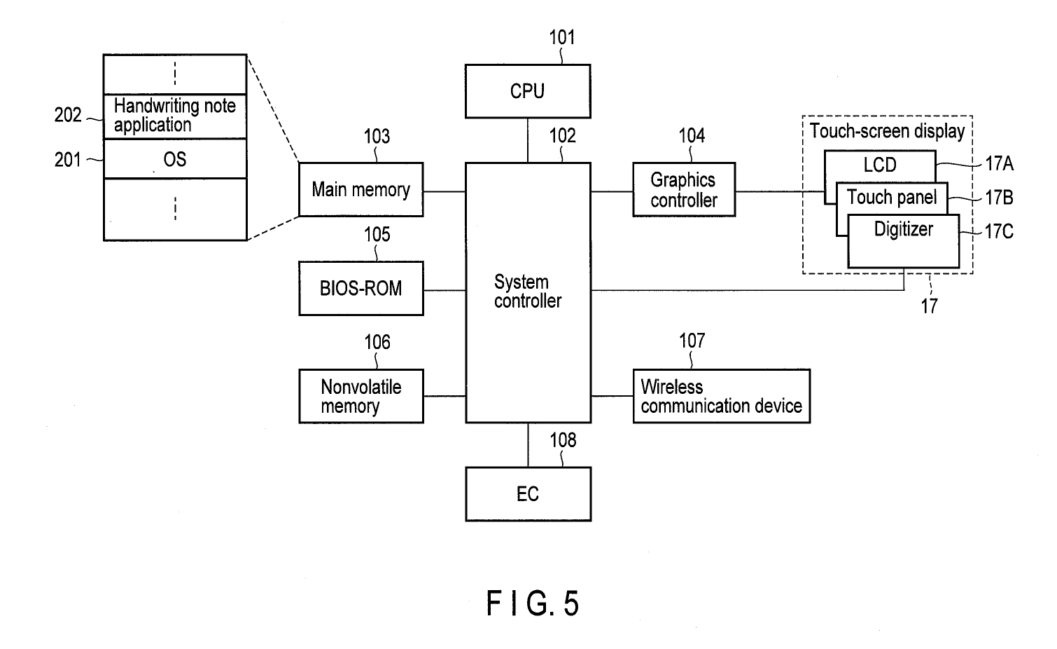

FIG. 5 shows a system configuration of the tablet computer 10.

As shown in FIG. 5, the tablet computer 10 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of programs, which are loaded from the nonvolatile memory 106 that is a storage device into the main memory 103. The programs include an operating system (OS) 201 and various application programs. The application programs include a handwriting note application program 202. The handwriting note application program 202 includes a function of creating and displaying the above-described handwritten document, and a function of editing the handwritten document.

Further, the handwriting note application program 202 includes a copy function for sending data, which corresponds to a handwritten document, to other various application programs via a clipboard. However, it is possible that other various applications do not have a capability of handling handwritten data (stroke data). Thus, even if handwritten data itself, which includes a plurality of stroke data corresponding to a plurality of strokes which are input by handwriting, is stored in the clipboard, there is a case in which other application programs have difficulty in making use of the handwritten data.

This being the case, in the present embodiment, when copy of a handwritten document has been requested, the handwriting note application program 202 automatically reshapes the handwritten document, and stores data, which has been obtained by the reshaping, in the clipboard. In this case, the data obtained by the reshaping is stored in the clipboard as data of a data format which is viewable by a plurality of application programs.

In this manner, when the handwritten document is to be copied to the clipboard, the handwriting note application program 202 executes an auto-reshaping process on the handwritten document to convert the handwritten document to data (digital document data), and stores the data obtained by the auto-reshaping process in the clipboard as data of a data format which can be viewed (or can be both viewed and edited) by a plurality of kinds of application programs. Accordingly, the handwritten document can be copied to the clipboard in a format which can be easily made use of by other application programs.

Various well-known data formats (also referred to as “file formats”) can be used for the data of the format which can be viewed by plural kinds of application programs. Examples of the data of the format, which can be viewed by plural kinds of application programs, include text, data described by a markup language (HTML, XML, etc.), vector data, image data, data of Word® of Microsoft Corporation, data of Excel® of Microsoft Corporation, and data of PowerPoint® of Microsoft Corporation.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B, LCD 17A and a digitizer 17C are laid over each other. The touch panel 17B is an electrostatic capacitance-type pointing device for executing an input on the screen of the LCD 17A. A contact position on the screen, which is touched by a finger, and a movement of the contact position are detected by the touch panel 17B. The digitizer 17C is an electromagnetic induction-type pointing device for executing an input on the screen of the LCD 17A. A contact position on the screen, which is touched by the pen (digitizer pen) 100, and a movement of the contact position are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

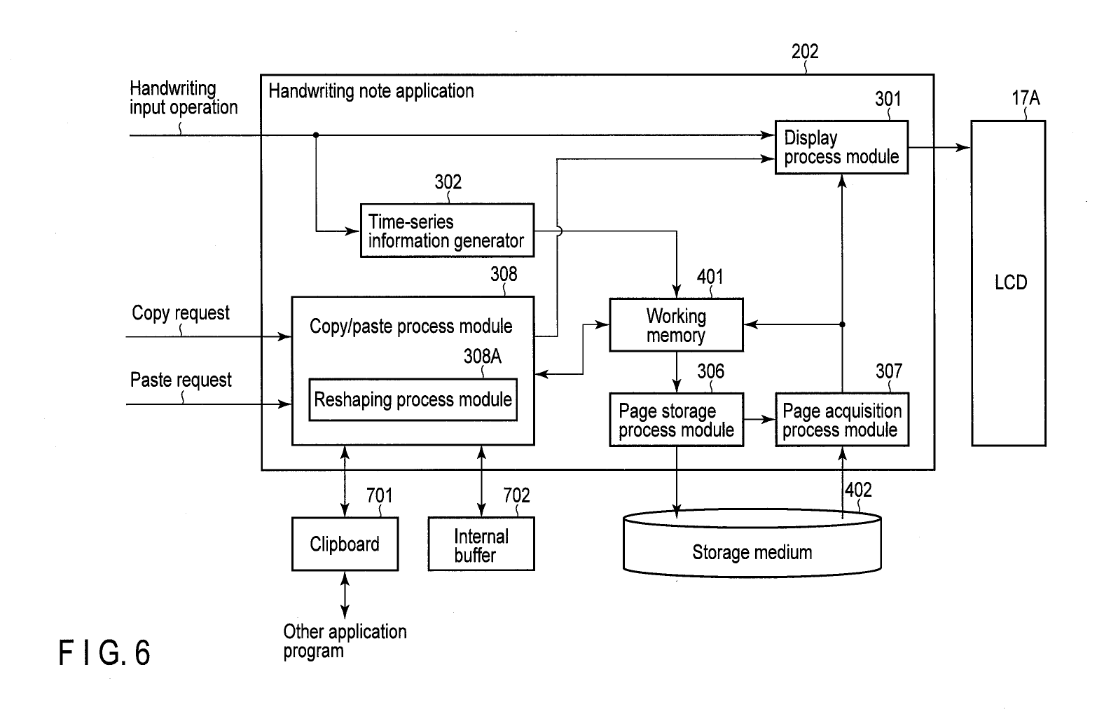

FIG. 6 illustrates a functional configuration of the handwriting note application program 202.

The handwriting note application program 202 is an application which can handle a handwritten document. The handwriting note application program 202 includes a display process module 301, a time-series information generator 302, a page storage process module 306, a page acquisition process module 307, and a copy/paste process module 308.

The handwriting note application program 202 creates, displays and edits a handwritten document (handwritten page) by using stroke data which is input by using the touch-screen display 17. The touch-screen display 17 is configured to detect the occurrence of events such as “touch (contact)”, “move (slide)” and “release”. The “touch (contact)” is an event indicating that an external object (pen or finger) has come in contact with the screen. The “move (slide)” is an event indicating that the position of contact of the external object has been moved while the external object is in contact with the screen. The “release” is an event indicating that the external object has been released from the screen.

The display process module 301 and time-series information generator 302 receive an event of “touch (contact)”, “move (slide)” or “release”, which is generated by the touch-screen display 17, thereby detecting a handwriting input operation. The “touch (contact)” event includes coordinates of a contact position of the pen 100. The “move (slide)” event includes coordinates of a contact position at a destination of movement of the pen 100. Accordingly, the display process module 301 and time-series information generator 302 can receive coordinate series corresponding to the locus of movement of the contact position from the touch-screen display 17.

The display process module 301 functions as a display processor configured to display a handwritten document including a plurality of stroke data corresponding to a plurality of strokes, which are input by handwriting, on the screen of the LCD 17A in the touch-screen display 17. The display process module 301 receives coordinate series from the touch-screen display 17. Then, based on the coordinate series, the display process module 301 displays on the screen of the LCD 17A strokes input by a handwriting input operation, with use of the pen 100 or the like.

Further, the display process module 301 can also display on the screen (edit screen) of the LCD 17A various data (handwritten data, image data, other various contents) which is pasted onto the handwriting note application program 202 by the copy/paste process module 308.

The time-series information generator 302 receives the above-described coordinate series which are output from the touch-screen display 17, and generates, based on the coordinate series, time-series information (handwritten data) which includes a plurality of stroke data corresponding to the above-described plural strokes. These stroke data, that is, the coordinates corresponding to the respective points of each stroke, may be temporarily stored in a working memory 401.

The page storage process module 306 stores in a storage medium 402 the handwritten data including a plurality of stroke data corresponding to a plurality of handwritten strokes on a handwritten page which is being created. The storage medium 402 may be, for example, the storage device in the tablet computer 10, or the storage device in the server computer 2. This handwritten document may include various contents which are obtained from other application programs.

The page acquisition process module 307 reads out arbitrary handwritten data from the storage medium 402. The read-out handwritten data is sent to the display process module 301. The display process module 301 displays on the screen a plurality of strokes corresponding to a plurality of stroke data included in the read-out handwritten data.

The copy/paste process module 308 functions a processor configured to execute a process for storing data, which corresponds to a currently displayed handwritten document, in a clipboard 701, if copy of the handwritten document has been requested by the user. The clipboard 701 is a temporary storage area for exchanging data between application programs. The copy/paste process module 308 includes a reshaping process module 308A. This reshaping process module 308A executes the above-described auto-reshaping process.

Specifically, the reshaping process module 308A recognizes a handwritten character string, a handwritten figure (handwritten shape) and a handwritten table in a handwritten document, and reshapes these handwritten character string, handwritten figure and handwritten table. In the process of reshaping, the reshaping process module 308A may convert the handwritten character string to text data. In addition, the reshaping process module 308A may convert the handwritten figure to shape object data (graphic object data) having a shape corresponding to this handwritten figure. Furthermore, the reshaping process module 308A may convert the handwritten table to table object data including cells corresponding to the handwritten table.

The copy/paste process module 308 stores in the clipboard 701 the data (reshaping result data) which has been obtained by reshaping the handwritten document by the reshaping process module 308A. In this case, the copy/paste process module 308 may convert the reshaping result data to data (electronic document data) having a data format which is viewable by a plurality of kinds of application programs.

In this manner, since the data, which is obtained by reshaping the handwritten document, is stored in the clipboard 701 as the data of the data format which can be viewed by a plurality of kinds of application programs, the content of the handwritten document can easily be made use of by other application programs.

However, there is a case in which various handwritten objects, such as a handwritten character string, a handwritten figure and a handwritten table, are exchanged between handwritten documents (handwritten pages) which are created by the handwriting note application program 202.

The exchange of a handwritten object between handwritten pages is required, for example, when a copy of content of a part of a certain handwritten page is to be pasted onto another handwritten page. In the exchange of a handwritten object between handwritten pages, it is preferable to exchange, not the reshaping result of the handwritten object, but the handwritten data itself which includes stroke data corresponding to the handwritten object.

Thus, in the present embodiment, if copy of a handwritten document has been requested, the copy/paste process module 308 executes a process of not only storing the reshaping result of the handwritten document in the clipboard 701, but also storing the handwritten data itself, which corresponds to the handwritten document, in an internal buffer 702.

The handwritten data, which corresponds to a handwritten document, is data including a plurality of stroke data corresponding to a plurality of strokes in this handwritten document. The internal buffer 702 is a temporary storage area which is different from the clipboard 701.

If paste of data onto the edit screen of the handwriting note application program 202 has been requested by the user, the copy/paste process module 308 automatically selects a temporary storage area, which is either the clipboard 701 or the internal buffer 702. Then, the latest data in the selected temporary storage area, that is, the data that was last stored in the selected temporary storage area, is pasted onto the edit screen. In the process for automatically selecting the temporary storage area, which is either the clipboard 701 or the internal buffer 702, the copy/paste process module 308 compares an update time corresponding to the latest data in the clipboard 701 and an update time corresponding to the latest data in the internal buffer 702.

The update time corresponding to the latest data in the clipboard 701 is indicative of a time at which this latest data was copied to the clipboard 701. This update time may be indicated by a time stamp which was added to this latest data. This time stamp may be added to the latest data as a part of the file name of the latest data.

The update time corresponding to the latest data in the internal buffer 702 is indicative of a time at which this latest data was copied to the internal buffer 702. This update time may also be indicated by a time stamp which was added to this latest data.

Then, in accordance with a comparison result between these update times, the copy/paste process module 308 pastes either the latest data in the clipboard 701 or the latest data in the internal buffer 702 onto the edit screen.

When the user has executed a copy operation during a period in which the handwriting note application program 202 is in the active state, the reshaping result corresponding to the handwritten data is copied to the clipboard 701, and the handwritten data is copied to the internal buffer 702, as described above. Accordingly, at this time point, since no new data is copied to the clipboard 701 by some other application program after the reshaping result of the handwritten document was copied to the clipboard 701, the update time corresponding to the latest data (the reshaping result of the handwritten document) in the clipboard 701 is equal to the update time corresponding to the latest data (handwritten data) in the internal buffer 702. In this case, the copy/paste process module 308 selects the internal buffer 702, and pastes the latest data in the internal buffer 702 onto the edit screen. Thereby, not the reshaping result, but the target handwritten data can be pasted onto the edit screen (handwritten page).

On the other hand, when new data has been copied to the clipboard 701 by some other application program after the reshaping result of the handwritten document was copied to the clipboard 701, the update time corresponding to the latest data in the clipboard 701 is later than the update time corresponding to the latest data in the internal buffer 702.

In this case, the copy/paste process module 308 selects the clipboard 701, and pastes the latest data in the clipboard 701 onto the edit screen (handwritten page). Thereby, the target data corresponding to the other application program can be pasted onto the edit screen (handwritten page).

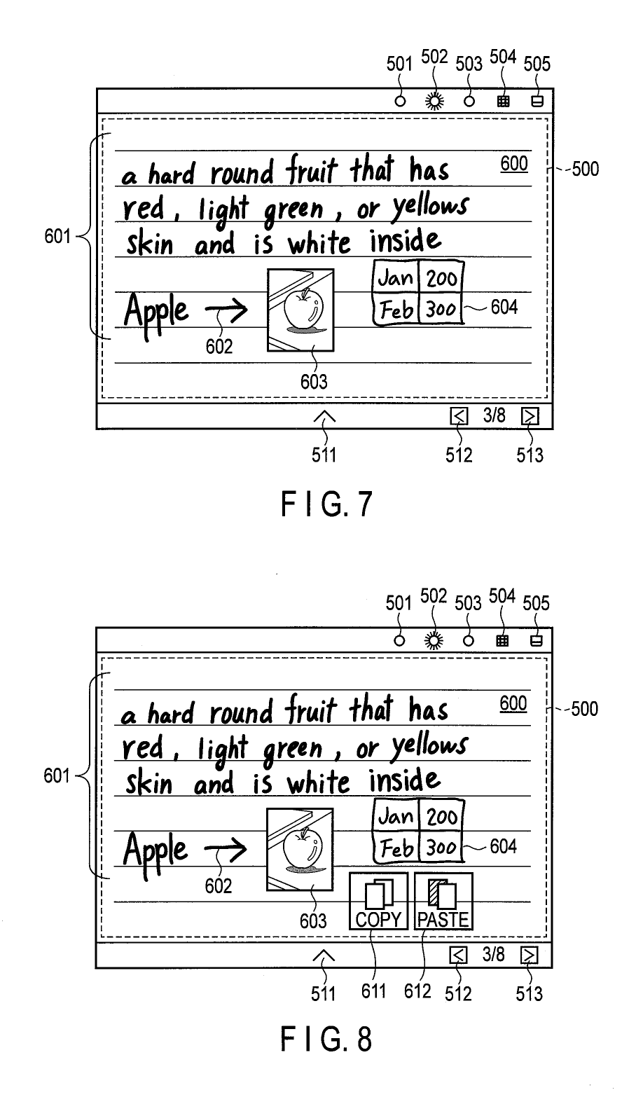

FIG. 7 illustrates an example of the edit screen.

The edit screen is a screen on which a handwriting input can be executed. This edit screen is used for newly creating a handwritten document (handwritten page), and for viewing and editing an existing handwritten document. On this edit screen, a rectangular area 500, which is surrounded by a broken line, is a handwriting input area which enables a handwriting input.

In the handwriting input area 500, input events from the digitizer 17C are used for display (drawing) of handwritten strokes. The edit screen further displays a quick select menu including three kinds of pens 501 to 503 which are pre-registered by the user, a range select pen 504 and an eraser pen 505. In this example, the case is assumed that a black pen 501, a red pen 502 and a marker 503 are pre-registered by the user. By tapping a certain pen (button) in the quick select menu by the pen 100 or a finger, the user can change the kind of pen that is used. For example, if a handwriting input operation using the pen 100 is executed on the edit screen in the state in which the black pen 501 is selected by a tap gesture with use of the pen 100 or a finger by the user, the handwriting note application program 202 displays on the edit screen a black stroke (locus) in accordance with the movement of the pen 100.

The edit screen further displays a menu button 511, a page back button 512, and a page forward button 513. The menu button 511 is a button for displaying a menu.

A handwritten document 600 includes a plurality of strokes which are input by handwriting, as described above. In addition, the handwritten document 600 may include data (e.g. image data) of another application program. In FIG. 7, the handwritten document 600 includes a background on which ruled lines are drawn, and a plurality of strokes which are displayed on the background. These strokes include strokes 601 corresponding to handwritten character strings, and strokes 602 corresponding to a handwritten arrow shape, and strokes 604 corresponding to a handwritten table. Further, the handwritten document 600 may include image data 603.

If the menu button 511 is tapped by the pen 100 or a finger, a copy button 611 and a paste button 612 are displayed on the edit screen, as illustrated in FIG. 8. The copy button 611 is a button for instructing that the data corresponding to the handwritten document on the edit screen is to be copied to the clipboard 701. The paste button 612 is a button for instructing that the copied data is to be pasted onto the edit screen.

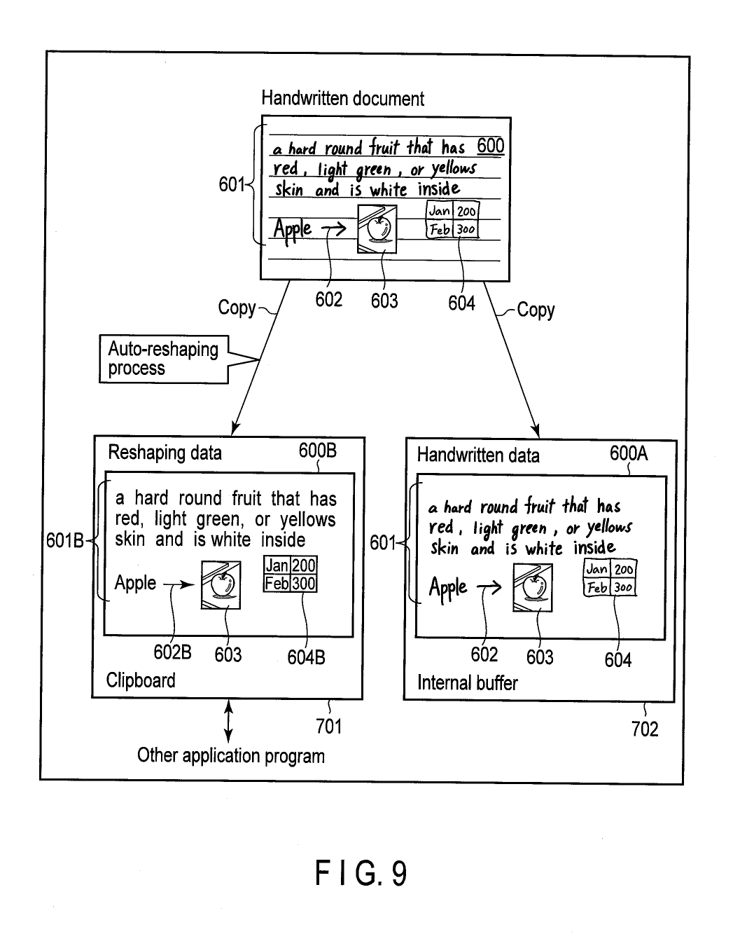

FIG. 9 illustrates a copy process which is executed by the handwriting note application program 202.

The copy process is started when the copy button 611 has been tapped by the pen 100 or a finger. Incidentally, the copy process is also started when a shortcut key operation of “Ctrl+C” has been executed by the user with use of a software keyboard which is displayed on the edit screen.

In the copy process, the copy/paste process module 308 executes a process for reshaping the handwritten document 600 by recognizing the handwritten characters, handwritten figure and handwritten table in the handwritten document 600. In the process of reshaping, at least one of the following processes is executed:

(1) A process of converting the handwritten character strings in the handwritten document 600 to text data.

(2) A process of converting the handwritten figure in the handwritten document 600 to shape object data (graphic object data), and

(3) A process of converting the handwritten table in the handwritten document 600 to table object data.

Reshaping data (electronic document data) 600B, which is obtained by reshaping (converting) the handwritten document 600, is stored in the clipboard 701 by the copy/paste process module 308. The shaping data 600B includes text data 601B which is a reshaping result corresponding to the handwritten character strings, arrow shape object data 602B which is a reshaping result corresponding to the handwritten arrow shape, and table object data 604B which is a reshaping result corresponding to the handwritten table. The reshaping data 600B is stored in the clipboard 701 as data having a data format which can be used by a plurality of kinds of application programs.

In this case, the text data 601B, arrow shape object data 602B, image data 603 and table object data 604B may be stored in the clipboard 701 as data (e.g. XML data) having a data format which can integrate these data. This XML data may be package data including some data. The package data may include a folder which stores the image data 603, and another folder. This another folder may store an XML file. This XML file may include an element in which the content of the text data 601B is described, an element indicative of the arrow shape object data 602B, an element indicative of the table object data 604B, and an element indicative of a path of the image data 603.

Alternatively, the text data 601B, arrow shape object data 602B, image data 603 and table object data 604B may be individually stored in the clipboard 701 as text data, vector data, image data, and spreadsheet data.

Further, in the copy process, the copy/paste process module 308 also executes a process of storing handwritten data 600A, which corresponds to the handwritten document 600, in the internal buffer 702.

In this case, the handwritten data 600A, which corresponds to the handwritten document 600 excluding the background, is stored in the internal buffer 702. The handwritten data 600A includes stroke data corresponding to the strokes 601 constituting the handwritten character strings, stroke data corresponding to the strokes 602 constituting the handwritten arrow shape, the image data 603, and stroke data corresponding to the strokes 604 constituting the handwritten table.

Although the case has been illustrated in which the reshaping data (electronic document data) corresponding to the entirety of the handwritten document 600 and the handwritten data corresponding to the entirety of the handwritten document 600 are copied, it is possible to copy reshaping data corresponding to a part of the handwritten document 600, which is designated by a range select operation that is executed by the user, and handwritten data corresponding to this part.

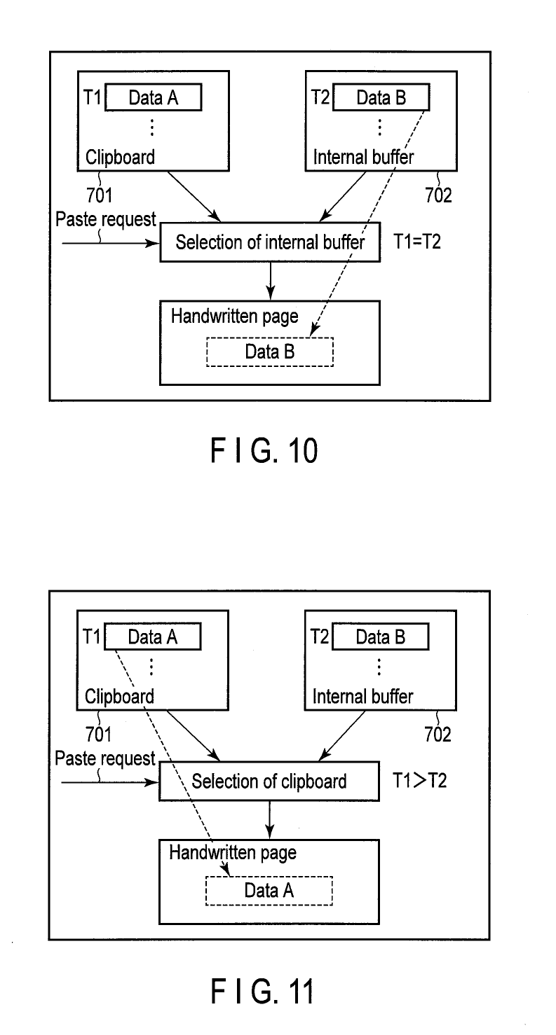

FIG. 10 illustrates a process of pasting data from the internal buffer 702, the process being executed by the handwriting note application program 202.

The paste process is started when the paste button 612 has been tapped by the pen 100 or a finger. Incidentally, the paste process is also started when a shortcut key operation of “Ctrl+V” has been executed by the user with use of the software keyboard which is displayed on the edit screen.

In the paste process, the copy/paste process module 308 compares a time stamp T1 (update time) of latest data A in the clipboard 701 and a time stamp T2 (update time) of latest data B in the internal buffer 702.

When the update time indicated by the time stamp T1 is substantially equal to the update time indicated by the time stamp T2, the copy/paste process module 308 selects the internal buffer 702, as illustrated in FIG. 10. Then, the copy/paste process module 308 pastes the latest data B in the internal buffer 702 onto the handwritten document (handwritten page) on the edit screen.

On the other hand, when the update time indicated by the time stamp T1 is later than the update time indicated by the time stamp T2, the copy/paste process module 308 selects the clipboard 701, as illustrated in FIG. 11. Then, the copy/paste process module 308 pastes the latest data A in the clipboard 701 onto the handwritten document (handwritten page) on the edit screen.

The reshaping method, which is applied to the handwritten document, may be changed in accordance with the kind of an application program which is a target onto which this handwritten document is pasted via the clipboard 701.

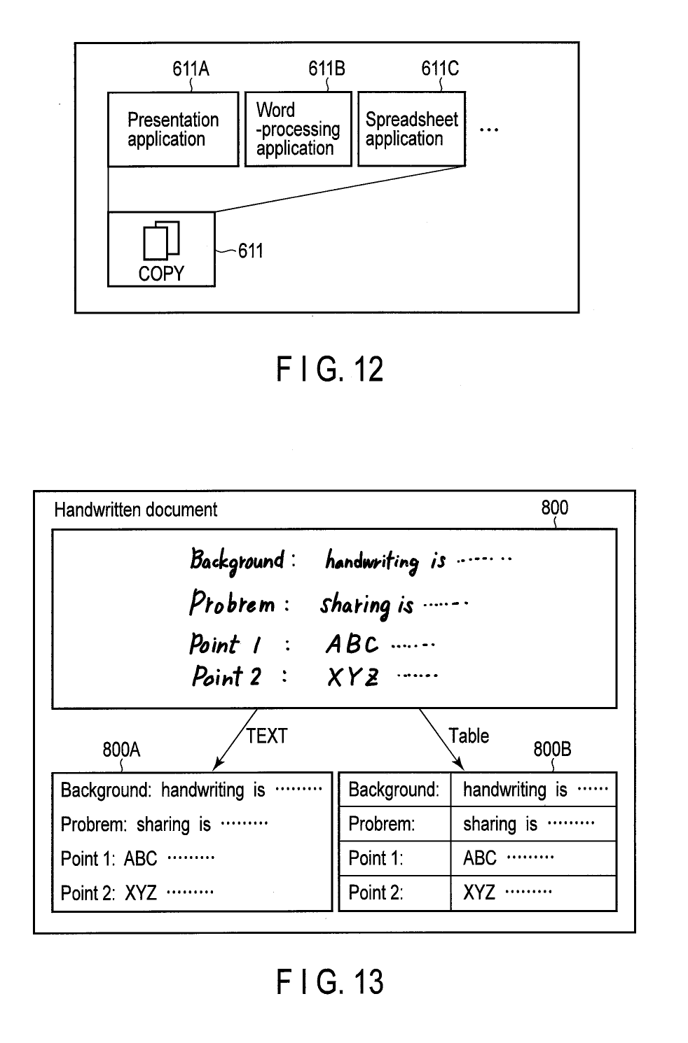

In this case, as illustrated in FIG. 12, when the copy button 611 has been tapped, some buttons for prompting the user to select a target application program may be displayed. FIG. 12 illustrates the case in which a “Presentation application” button 611A, a “Word-processing application” button 611B and a “Spreadsheet application” button 611C are displayed. The copy/paste process module 308 can switch, among a plurality of kinds of reshaping methods, a reshaping method which is used in order to reshape a handwritten document, according to which of the “Presentation application” button 611A, “Word-processing application” button 611B and “Spreadsheet application” button 611C is tapped by the user.

For example, there is a case in which a handwritten document, which is a target of reshaping, includes a handwritten document part which can be converted to any one of text, a table and a text box. Examples of such a handwritten document part include (1) a handwritten document part including handwritten character strings corresponding to some headings, and handwritten character strings corresponding to the contents of the respective headings, and (2) a handwritten document part including some handwritten character strings which are itemized.

The case is now assumed that a handwritten document 800 illustrated in FIG. 13 is to be reshaped. The handwritten document 800 is a handwritten document which can be converted to any one of text, a table and a text box.

When the “Word-processing application” button 611B has been selected by the user, the copy/paste process module 308 may reshape the handwritten document 800 by using a reshaping method for converting handwritten character strings to text data. In this case, the handwritten document 800 is converted to text data 800A which is shown in a lower left part of FIG. 13.

When the “Spreadsheet application” button 611C has been selected by the user, the copy/paste process module 308 may reshape the handwritten document 800 by using a reshaping method for converting some handwritten character strings to some cells. In this case, the handwritten document 800 is converted to table object data 800B which is shown in a lower right part of FIG. 13.

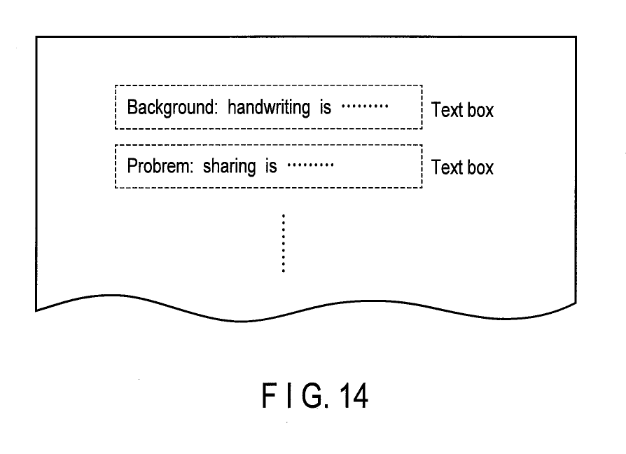

When the “Presentation application” button 611A has been selected by the user, the copy/paste process module 308 may reshape the handwritten document 800 by using a reshaping method for converting respective handwritten character strings to text boxes. In this case, each character string in the handwritten document 800 is converted to text box data, as illustrated in FIG. 14.

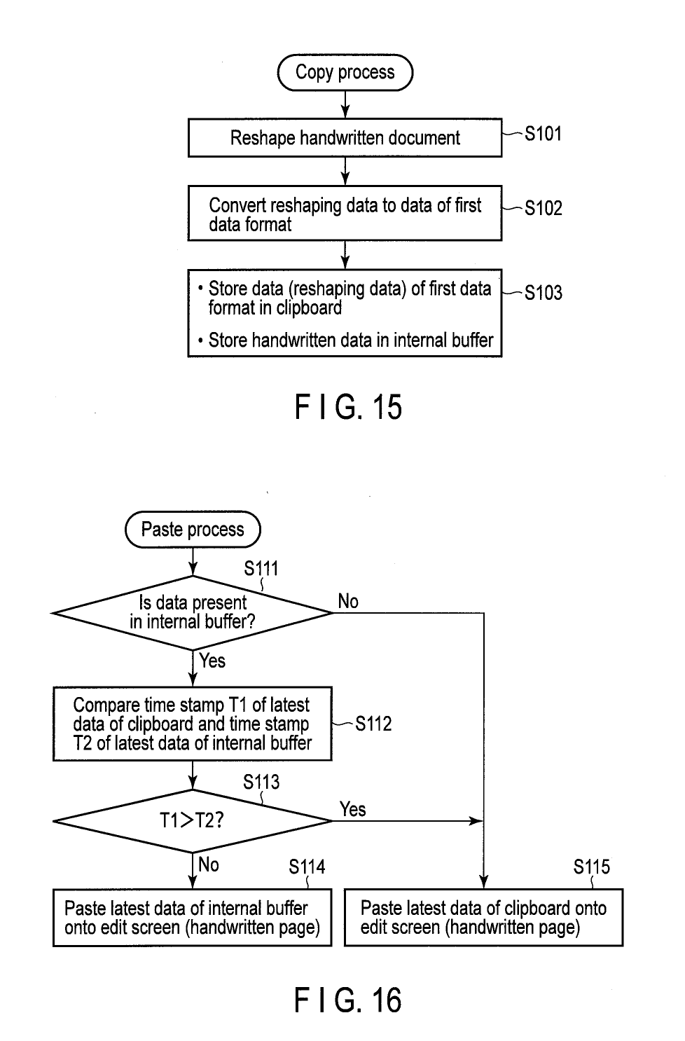

A flowchart of FIG. 15 illustrates a procedure of a copy process which is executed by the copy/paste process module 308.

When copy of a handwritten document has been requested, for example, when the copy button 611 has been tapped by the user, the copy/paste process module 308 reshapes the handwritten document by recognizing the handwritten document on the edit screen (step S101). In step S101, the respective handwritten objects (a handwritten character string, a handwritten figure, a handwritten table, etc.) in the handwritten document are recognized and reshaped. In this case, the handwritten character string is converted to text data, the handwritten figure is converted to shape object data, and the handwritten table is converted to table object data.

Subsequently, the copy/paste process module 308 converts reshaping data, which is obtained by reshaping the handwritten document, to data having a first data format which can be used by a plurality of kinds of application programs (step S102).

The copy/paste process module 308 stores the data (reshaping data) having the first data format in the clipboard 701 (step S103). Furthermore, in step S103, the copy/paste process module 308 stores handwritten data corresponding to the handwritten document, that is, handwritten data including a plurality of stroke data, in the internal buffer 702.

A flowchart of FIG. 16 illustrates a procedure of a paste process which is executed by the copy/paste process module 308.

When paste of data onto the edit screen, which enables a handwriting input, has been requested, for example, when the paste button 612 has been tapped by the user, the copy/paste process module 308 first determines whether data is present in the internal buffer 702 (step S111).

If no data is present in the internal buffer 702 (NO in step S111), the copy/paste process module 308 pastes the latest data in the clipboard 701 onto the edit screen (handwritten page) (step S115).

If data is present in the internal buffer 702 (YES in step S111), the copy/paste process module 308 compares the time stamp T1 of the latest data in the clipboard 701 and the time stamp T2 of the latest data in the internal buffer 702 (step S112).

If the time stamp T1 is greater than the time stamp T2, that is, if the update time corresponding to the latest data in the clipboard 701 is later than the update time corresponding to the latest data in the internal buffer 702 (YES in step S113), the copy/paste process module 308 pastes the latest data in the clipboard 701 onto the edit screen (handwritten page) (step S115).

On the other hand, if the time stamp T1 is substantially equal to the time stamp T2 (NO in step S113), the copy/paste process module 308 pastes the latest data in the internal buffer 702 onto the edit screen (handwritten page) (step S114).

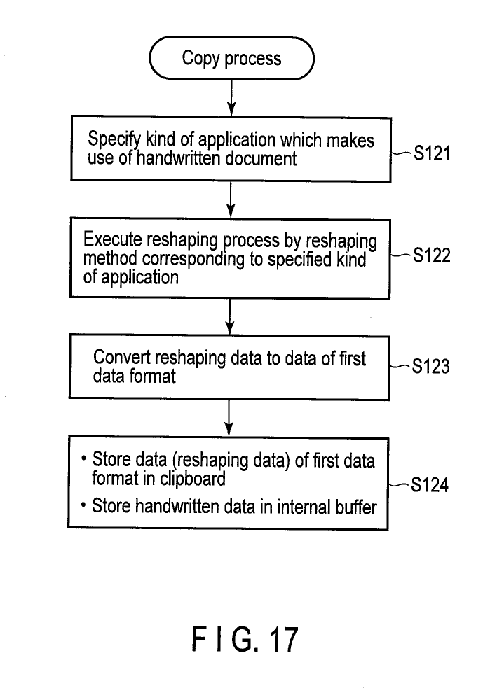

A flowchart of FIG. 17 illustrates another procedure of the copy process which is executed by the copy/paste process module 308.

When copy of a handwritten document has been requested, for example, when the copy button 611 has been tapped by the user, the copy/paste process module 308 starts a copy process. The copy/paste process module 308 executes a process for specifying the kind of application program which makes use of the handwritten document, that is, the kind of application program of a target onto which data corresponding to the handwritten document is pasted via the clipboard 701 (step S121). In step S121, the copy/paste process module 308 may display some buttons 161A, 161B, 161C, . . . , which are illustrated in FIG. 12, and may prompt the user to designate the kind of the application program of the target.

In the meantime, there may be a case in which some user always uses only a specific kind of application program as an application program which makes use of a handwritten document. Thus, a setup process may be executed for presetting the kind of the application program of the target. In this case, the copy/paste process module 308 is able to specify the kind of application program which makes use of the handwritten document, by referring to a setup file.

Subsequently, the copy/paste process module 308 executes a reshaping process of a handwritten document, by using a reshaping method corresponding to the specified kind of application program (step S122). In step S122, when the specified kind of application program is a first kind of application program, the copy/paste process module 308 reshapes the handwritten document by using a first reshaping method corresponding to the first kind of application program. In addition, when the specified kind of application program is a second kind of application program, the copy/paste process module 308 reshapes the handwritten document by using a second reshaping method which is different from the first reshaping method. The second reshaping method corresponds to the second kind of application program.

Next, the copy/paste process module 308 converts reshaping data, which is obtained by reshaping the handwritten document, to data having a first data format which can be used by a plurality of kinds of application programs (step S123). The copy/paste process module 308 stores the data (reshaping data) having the first data format in the clipboard 701 (step S124). Furthermore, in step S124, the copy/paste process module 308 stores handwritten data corresponding to the handwritten document, that is, handwritten data including a plurality of stroke data, in the internal buffer 702.

As has been described above, in the present embodiment, the process for reshaping the handwritten document to convert the handwritten document to first data of a first data format viewable by a plurality of kinds of application programs is executed. Then, not the handwritten data itself (plural stroke data) corresponding to the handwritten document, but the first data obtained by the reshaping of the handwritten document (a handwritten character string, a handwritten figure, a handwritten table, etc.) is stored in the clipboard 701. Therefore, it is possible to make it easier for a handwritten document to be made use of by other application programs.

Furthermore, since the handwritten data itself (plural stroke data) corresponding to the handwritten document is stored in the internal buffer 702, the handwritten data can efficiently be shared between handwritten documents.

Since the various processes in the embodiment can be realized by a computer program, the same advantageous effects as with the present embodiment can easily be obtained simply by installing the computer program into an ordinary computer through a computer-readable storage medium which stores the computer program, and executing the computer program.

The CPU in the computer, in which this computer program is installed, may function as a processor configured to execute the copy/paste process. The GPU in this computer may function as a display processor configured to display each of strokes on the screen.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display processor configured to display on a screen a handwritten document comprising a plurality of handwritten strokes; and
a processor configured to execute a process to convert the handwritten document to first data of a first data format viewable by a plurality of application programs and to store the first data in a clipboard for exchanging data between application programs, when a copy of the handwritten document is requested.

2. The electronic device of claim 1,
wherein when the copy of the handwritten document is requested, the processor is configured to store handwritten data corresponding to the handwritten document in a temporary storage area different from the clipboard, the handwritten data comprising a plurality of stroke data corresponding to the plurality of handwritten strokes,
wherein when pasting of data onto an edit screen of a first application program configured to process the handwritten data is requested, the processor is configured to paste onto the edit screen either one of first latest data in the clipboard or second latest data in the temporary storage area, and
wherein the either one of the first latest data or the second latest data is determined in accordance with a first update time corresponding to the first latest data and a second update time corresponding to the second latest data.

3. The electronic device of claim 1,
wherein the processor is configured:
to execute the process by using a first reshaping method when data corresponding to the handwritten document is to be pasted onto a first kind of application program, and to execute the process by using a second shaping method different from the first shaping method when the data corresponding to the handwritten document is to be pasted onto a second kind of application program.

4. The electronic device of claim 1,
wherein the process comprises a first process for converting a handwritten character string in the handwritten document to text data.

5. The electronic device of claim 1,
wherein the process comprises at least one of a first process of converting a handwritten character string in the handwritten document to text data, a second process of converting a handwritten figure in the handwritten document to shape object data, and a third process of converting a handwritten table in the handwritten document to table object data.

6. A method of processing handwritten data by an electronic device, the method comprising:
displaying on a screen a handwritten document comprising a plurality of handwritten strokes;
executing a process to convert the handwritten document to first data of a first data format viewable by a plurality of application programs when a copy of the handwritten document is requested; and
storing the first data in a clipboard for exchanging data between application programs.

7. The method of claim 6, further comprising:
storing handwritten data corresponding to the handwritten document in a temporary storage area different from the clipboard whey the copy of the handwritten document is requested, the handwritten data comprising a plurality of stroke data corresponding to the plurality of handwritten strokes; and
pasting either one of first latest data in the clipboard or second latest data in the temporary storage area onto an edit screen of a first application program configured to process the handwritten data when pasting of data onto the edit screen is requested,
wherein the either one of the first latest data or the second latest data is determined in accordance with a first update time corresponding to the first latest data and a second update time corresponding to the second latest data.

8. The method of claim 6,
wherein the executing comprises:
executing the process by using a first reshaping method when data corresponding to the handwritten document is to be pasted onto a first kind of application program, and executing the process by using a second shaping method different from the first shaping method when the data corresponding to the handwritten document is to be pasted onto a second kind of application program.

9. The method of claim 6,
wherein the process comprises a first process for converting a handwritten character string in the handwritten document to text data.

10. The method of claim 6,
wherein the process comprises at least one of a first process of converting a handwritten character string in the handwritten document to text data, a second process of converting a handwritten figure in the handwritten document to shape object data, and a third process of converting a handwritten table in the handwritten document to table object data.

11. A computer-readable, non-transitory storage medium having stored thereon a computer program configured to be executable by a computer, the computer program controlling the computer to execute functions of:
displaying on a screen a handwritten document comprising a plurality of handwritten strokes;
executing a process to convert the handwritten document to first data of a first data format viewable by a plurality of application programs when a copy of the handwritten document is requested; and
storing the first data in a clipboard for exchanging data between application programs.

12. The storage medium of claim 11,
wherein the computer program further controls the computer to execute functions of:
storing handwritten data corresponding to the handwritten document in a temporary storage area different from the clipboard when the copy of the handwritten document is requested, the handwritten data comprising a plurality of stroke data corresponding to the plurality of handwritten strokes; and
pasting either one of first latest data in the clipboard or second latest data in the temporary storage area onto an edit screen of a first application program configured to process handwritten data when pasting of data onto the edit screen is requested,
wherein the either one of the first latest data or the second latest data is determined in accordance with a first update time corresponding to the first latest data and a second update time corresponding to the second latest data.

13. The storage medium of claim 11,
wherein the executing comprises:
executing the process by using a first reshaping method when data corresponding to the handwritten document is to be pasted onto a first kind of application program, and executing the process by using a second shaping method different from the first shaping method when the data corresponding to the handwritten document is to be pasted onto a second kind of application program.

14. The storage medium of claim 11,
wherein the process comprises a first process for converting a handwritten character string in the handwritten document to text data.

15. The storage medium of claim 11,
wherein the process for reshaping the handwritten document comprises at least one of a first process of converting a handwritten character string in the handwritten document to text data, a second process of converting a handwritten figure in the handwritten document to shape object data, and a third process of converting a handwritten table in the handwritten document to table object data.
